(19) United States
(12) Patent Application Publication
(10) Pub. No.: US 2018/0004287 A1
(43) Pub. Date: Jan. 4, 2018

(54) METHOD FOR PROVIDING USER INTERFACE THROUGH HEAD MOUNTED DISPLAY USING EYE RECOGNITION AND BIO-SIGNAL, APPARATUS USING SAME, AND COMPUTER READABLE RECORDING MEDIUM

(71) Applicants: KOREA ADVANCED INSTITUTE OF SCIENCE AND TECHNOLOGY, Daejeon (KR); UX FACTORY CO., LTD., Daejeon (KR)

(72) Inventors: Hoi Jun YOO, Daejeon (KR); In Joon Hong, Daejeon (KR); Kyeong Ryeol BONG, Seoul (KR); Jun Young PARK, Chungcheonbuk-do (KR)

(73) Assignees: KOREA ADVANCED INSTITUTE OF SCIENCE AND TECHNOLOGY, Daejeon (KR); UX FACTORY CO., LTD., Daejeon (KR)

(21) Appl. No.: 15/542,933

(22) PCT Filed: Dec. 4, 2015
(86) PCT No.: PCT/KR2015/013189

§ 371 Date: Jul. 12, 2017

(30) Foreign Application Priority Data
Jan. 16, 2015 (KR) 10-2015-0008202

(51) Int. Cl. G06F 3/01; G06T 7/246; G02B 27/01; G06F 3/0481

(52) U.S. Cl. CPC G06F 3/013; G06F 3/0481; G06T 7/248; G02B 27/017

(57) ABSTRACT

A method for providing a user interface through a head mounted display using eye recognition and bio-signals comprises the steps of: (a) moving a cursor to a particular location at which a user gazes by referencing the eye information obtained from a first eyeball that is one of the eyeballs of the user through a camera module when the user gazes at a particular location on an output screen; and (b) supporting in order to provide detailed selection items corresponding to an entity when a certain entity exists in the certain position by referencing the movement information obtained from the eyelid corresponding to a second eyeball that is one of the eyeballs of the user through a bio-signal acquisition module.

### TECHNICAL FIELD

The present invention relates to a method of providing a user interface through a head mount display using eyes recognition and a bio-signal and an apparatus and computer-readable recording medium using the same and, more particularly, to a method of outputting a specific graphic user interface (GUI) to a specific location of a screen provided by a head mount display, moving a cursor to the specific location watched by a user with reference to at least one of eyes information obtained from the first eyeball of the user through a camera module and eyes information obtained from the second eyeball of the user through a bio-signal acquisition module when the user looks at the specific location of the output graphic user interface, and in the state in which a graphic entity provided by the GUS is present at the specific location, (i) performing support so that the graphic entity is selected with reference to motion information obtained from an eyelid corresponding to the first eyeball of the user through the camera module and (ii) performing support so that a detailed selection item corresponding to the graphic entity is provided with reference to motion information obtained from an eyelid corresponding to the second eyeball of the user through the bio-signal acquisition module, and an apparatus and computer-readable recording medium using the same.

### BACKGROUND ART

A user interface widely used in the existing head mount display includes a user interface based on voice recognition, which can transfer a complicated command to an HMD without using both hands. However, the user interface using voice has problems in that it is difficult to use in public because a voice is used as a command and it is difficult to transfer personal information, such as an address, telephone number or password, to the HMD in public because a command issued to the HDM by a user is exposed to surrounding persons.

U.S. Patent Application Publication No. 2006-0061544 discloses a unit which recognizes a bio-signal as the input of a key by sensing the bio-signal including a voltage generated from a user's face in an HMD. The unit may sense a bio-signal, may recognize key information according to the sensed bio-signal as the input of a specific key, and may issue a command to the HMD even in a public place. In order to recognize the sensed key information as the input of the specific key, first, the specific key by which the input of the key is to be executed must be pointed. However, it is difficult to accurately point the specific key based on only the key information obtained from the bio-signal.

Accordingly, the inventors of the present invention propose a method of providing a user interface and an apparatus using the same, wherein separate modules are installed on both eyes, respectively, so that a user can issues a command to an HMD conveniently and accurately.

### DISCLOSURE

### Technical Problem

An object of the present invention is to solve all of the aforementioned problems.

Another object of the present invention is to enable more accurate and various user inputs by dividing a measurement module used in a first eyeball and a second eyeball into a camera module and a bio-signal acquisition module.

### Technical Solution

Characteristic configurations of the present invention for achieving objects of the present invention, such as that described above, and for realizing characteristics effects of the present invention to be described later are as follows.

In accordance with one aspect of the present invention, there is provided a method of providing a user interface through a head mount display using eyes recognition and a bio-signal, including the steps of (a) moving a cursor to a specific location watched by a user with reference to eyes information obtained from a first eyeball that is any one of the eyeballs of the user through a camera module when the user looks at the specific location of a displayed screen and (b) providing support so that a detailed selection item corresponding to a specific entity is provided with reference to motion information obtained from an eyelid corresponding to a second eyeball that is any one of the eyeballs of the user through a bio-signal acquisition module in the state in which the specific entity is present at the specific location.

In accordance with another aspect of the present invention, there is provided a head mount display device providing a user interface using eyes recognition and a bio-signal, including a camera module which obtains eyes information from a first eyeball that is any one of the eyeballs of a user, a bio-signal acquisition module which obtains motion information from an eyelid corresponding to a second eyeball that is any one of the eyeballs of the user, and a user interface providing unit (1) which moves a cursor to a specific location watched by the user with reference to the eyes information obtained from the first eyeball of the user through the camera module when the user looks at the specific location of a displayed screen and (2) which provides support so that a detailed selection item corresponding to a specific entity is provided with reference to the motion information obtained from the eyelid corresponding to the second eyeball of the user through the bio-signal acquisition module in the state in which the specific entity is present at the specific location.

In addition, there is further provided a computer-readable recording medium for recording a computer program for executing the method of the present invention.

### Advantageous Effects

The present invention has an effect in that it can be used in a user-friendly manner compared to a common HMD because a measurement module applied to a first eyeball and a second eyeball are divided into a camera module and a bio-signal acquisition module and various types of user input are implemented through the camera module and the bio-signal acquisition module.

### DESCRIPTION OF DRAWINGS

FIG. 1 is a schematic diagram of a head mount display implemented in the form of glasses according to an embodiment of the present invention.

FIG. 2 is a flowchart illustrating a process of processing, by a user, a graphic entity displayed on the head mount display with both eyes according to an embodiment of the present invention.

FIGS. 3a to 3c illustratively show a process of selecting, by a user, a graphic entity displayed on the head mount display with both eyes according to an embodiment of the present invention.

FIG. 4 illustratively shows a graphic user interface displayed on the head mount display according to an embodiment of the present invention.

### DESCRIPTION OF REFERENCE NUMERALS

110: display unit

120: camera module

130: EOG electrode

135: bio-signal acquisition module

140: processor

### BEST MODE FOR INVENTION

The present invention is a method of providing a user interface through a head mount display using eyes recognition and a bio-signal, including the steps of (a) moving a cursor to a specific location watched by a user with reference to eyes information obtained from a first eyeball that is any one of the eyeballs of the user through a camera module when the user looks at the specific location of a displayed screen and (b) providing support so that a detailed selection item corresponding to a specific entity is provided with reference to motion information obtained from an eyelid corresponding to a second eyeball that is any one of the eyeballs of the user through a bio-signal acquisition module in the state in which the specific entity is present at the specific location.

At the step (b), the support may be provided so that the entity is selected with reference to motion information obtained from an eyelid corresponding to the first eyeball of the user through the camera module.

The first eyeball and the second eyeball may be one identical eyeball of the user.

The bio-signal acquisition module includes a plurality of electrodes attached to a skin around the second eyeball. A location for recognizing the direction of a motion of the eyelid corresponding to the second eyeball may be determined to be the location where the plurality of electrodes is attached.

The eyes information obtained from the first eyeball of the user may be derived by a processor which performs a specific eyes tracking algorithm and the camera module which photographs the first eyeball of the user.

The eyes tracking algorithm may photograph the first eyeball of the user using the camera module, may search the photographed image for the central location of the pupil of the first eyeball, and may calculate a point on the screen watched by the user.

The bio-signal may include information according to electrooculogram (EOG).

Furthermore, the present invention is a head mount display device providing a user interface using eyes recognition and a bio-signal, including a camera module which obtains eyes information from a first eyeball that is any one of the eyeballs of a user, a bio-signal acquisition module which obtains motion information from an eyelid corresponding to a second eyeball that is any one of the eyeballs of the user, and a user interface providing unit (1) which moves a cursor to a specific location watched by the user with reference to the eyes information obtained from the first eyeball of the user through the camera module when the user looks at the specific location of a displayed screen and (2) which provides support so that a detailed selection item corresponding to a specific entity is provided with reference to the motion information obtained from the eyelid corresponding to the second eyeball of the user through the bio-signal acquisition module in the state in which the specific entity is present at the specific location.

The user interface providing unit may provide support so that the graphic entity is selected with reference to motion information obtained from an eyelid corresponding to the first eyeball of the user through the camera module.

The first eyeball and the second eyeball may be one identical eyeball of the user.

The bio-signal acquisition module includes a plurality of electrodes attached to a skin around the second eyeball. Locations for recognizing a direction of a motion of the eyelid corresponding to the second eyeball may be determined to be locations where the plurality of electrodes is attached.

The camera module may photograph the first eyeball of the user and may obtain the eyes information obtained from the first eyeball of the user under the support of the processor performing a specific eyes tracking algorithm.

The camera module may obtain the eyes information obtained from the first eyeball of the user under a support of an eyes tracking algorithm which photographs the first eyeball of the user, may search the photographed image for the central location of the pupil of the first eyeball, and may calculate a point on the graphic user interface watched by the user.

The bio-signal may include information according to electrooculogram (EOG).

The screen may be disposed outside glasses.

### MODE FOR INVENTION

Specific embodiments of the present invention are described in detail below with reference to the accompanying drawings. The embodiments are described in detail in order for those skilled in the art to readily implement the present invention. It is to be understood that the various embodiments of the present invention are different from each other, but do not need to be exclusive. For example, a specific shape, structure and characteristic described in this specification in connection with an embodiment may be implemented as another embodiment without departing from the spirit and scope of the present invention. It is also to be understood that the position or arrangement of an individual element within each disclosed embodiment may be changed without departing from the spirit and scope of the present invention. Accordingly, the detailed description hereinafter is not intended to have a limited meaning, and the range of right of the present invention is restricted by only the attached claims along with the entire range equivalent to things claimed by the claims, if it is appropriately described. Similar reference numerals in the drawings denote the same or similar functions from several aspects.

Hereinafter, preferred embodiments of the present invention are described in detail with reference to the accompanying drawings in order for a person having ordinary skill in the art to which the present invention pertains to readily implement the present invention.

For reference, the type of a head mount display described in the present invention is various, but it is assumed that the type of the head mount display is a glasses type in an embodiment of the present invention for convenience of description.

Furthermore, in an embodiment of the present invention, the first eyeball of a user may be a right eye and the second eyeball of the user may be a left eye. A bio-signal obtained from the second eyeball of a user by a bio-signal acquisition module to be described later may be based on electrooculogram (EOG), but is not limited thereto. Furthermore, the first eyeball or second eyeball of the present invention may mean any one of the same eyeballs of a user, but has been illustrated as indicating another eyeball hereinafter, for convenience of description. If the first eyeball and the second eyeball indicate the same eyeball, a camera module to be described later and the bio-signal acquisition module to be described later will be configured in the periphery of the same eyeball.

Furthermore, in the drawings of the present invention and the description thereof, a graphic user interface, that is, a GUI, has been illustrated, but the selection of an entity according to the present invention does not need to be essentially performed based on a GUI.

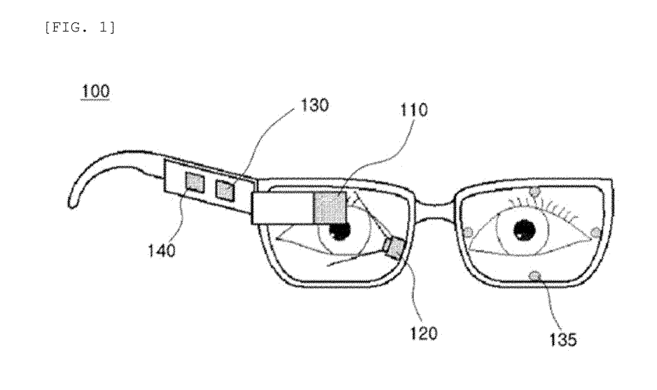

FIG. 1 is a schematic diagram of a head mount display implemented in the form of glasses according to an embodiment of the present invention.

Referring to FIG. 1, the head mount display device 100 may include a display unit 110, a camera module 120, a bio-signal acquisition module 130, and a user interface providing unit (not shown). Furthermore, the head mount display device 100 may further include a processor 140 for performing an eyes tracking algorithm and may further include a plurality of electrodes 135 included in the bio-signal acquisition module 130.

Specifically, the display unit 110 may be disposed to be overlapped with some region of the right lens of the head mount display, for example and may output a specific graphic user interface by the user interface providing unit.

Next, the camera module 120 may obtain eyes information from the first eyeball of a user or may obtain motion information from an eyelid corresponding to the first eyeball of the user. In this case, the camera module 120 may function to photograph the first eyeball of the user and to obtain eyes information obtained from the first eyeball of the user under the support of the processor 140 which performs a specific eyes tracking algorithm. In this case, the eyes tracking algorithm may function to search the captured image of the first eyeball for the central location of the pupil of the first eyeball and to calculate a point on a graphic user interface at which the user tries to look.

In this case, the camera module 120 may be disposed at a specific location of a right lens and may be a monocular configuration having a single camera by disposing the camera module only on the right lens side. In general, if the eyes of a person who looks at a surrounding environment are recognized using a camera, the eyes of the person are recognized using a binocular configuration having two cameras because the distance between an object watched by the person and the person is not constant. In the present invention, however, since the eyes of a person who looks at a graphic user interface on a screen are recognized, the distance between a screen, that is, a graphic user interface displayed on the display unit 110, and the person is constant. Accordingly, the camera module 120 for eyes recognition may have a monocular configuration.

Furthermore, the bio-signal acquisition module 130 may obtain motion information from an eyelid corresponding to the second eyeball of a user. In this case, the bio-signal acquisition module 130 may include the plurality of electrodes 135 attached to a skin around the second eyeball. The location where the plurality of electrodes 135 is attached may be determined as a location for recognizing the direction of a motion of the eyelid corresponding to the second eyeball. For example, when the electrodes 135 are attached to the up, down, left and right of the second eyeball as shown in FIG. 1, the direction of a motion of an eyelid corresponding to the second eyeball can be accurately recognized. Of course, the number of electrodes 135 attached will not be limited. Furthermore, the bio-signal may include information according to electrooculogram (EOG), but is not limited thereto.

Furthermore, by configuring the camera module 120 for eyes recognition in a monocular type, electrodes 135 that operate in conjunction with the bio-signal acquisition module 130 may be disposed on a skin around the eyeball on the left lens side in which the camera module 120 has not been disposed. For example, the bio-signal acquisition module 130 may be an electrooculogram (EOG) sensor. In this case, corresponding motion information can be obtained by sensing EOG from the eyelid of the second eyeball of a user through the electrode 135.

In this case, the EOG sensor 130 has very small power consumption because it can sense EOG using a simple amplifier and ADC. Accordingly, power consumption of the head mount display 100 can be reduced by obtaining information about motions of both eyes of a user using both the EOG sensor 130 and the camera module 120 rather than obtaining information about motions of both eyes of the user using a binocular type camera having great power consumption in the head mount display device 100. Furthermore, the EOG signal sensed from the second eyeball of the user has a small amount of data, and thus the computational load and required memory capacity of an algorithm for processing the data are small. Accordingly, a processor and hardware for processing the EOG signal can be implemented conveniently.

Next, the user interface providing unit may display a specific graphic user interface (GUI) at a specific location of a screen (i.e., the display unit 110) corresponding to the head mount display device 100. In this case, the screen corresponding to the head mount display device 100 may mean a screen of a display connected through wireless or wired communication, and may be a concept including a case where a display is disposed in a head mount display itself, such as glasses, and a case where a display is separately disposed outside glasses. Meanwhile, in this case, when a user looks at a specific location of the GUI output through the screen, a motion of a cursor to the specific location watched by the user can be displayed with reference to eyes information obtained from the first eyeball of the user through the camera module 120. Furthermore, if a specific graphic entity provided by the GUI is present at the specific location to which the cursor has moved, the user interface providing unit can provide support so that the graphic entity is selected with reference to motion information obtained from an eyelid corresponding to the first eyeball of the user through the camera module 120. In this case, the motion information obtained from the eyelid corresponding to the first eyeball is a concept including information about a motion, nystagmus and widened degree of the eyelid of the first eyeball. Furthermore, the user interface providing unit may provide support so that a detailed selection item corresponding to the graphic entity is provided with reference to the motion information obtained from an eyelid corresponding to the second eyeball of the user through the bio-signal acquisition module 130. In this case, the motion information obtained from the eyelid corresponding to the second eyeball is a concept including information about a motion, nystagmus and widened degree of the eyelid of the second eyeball.

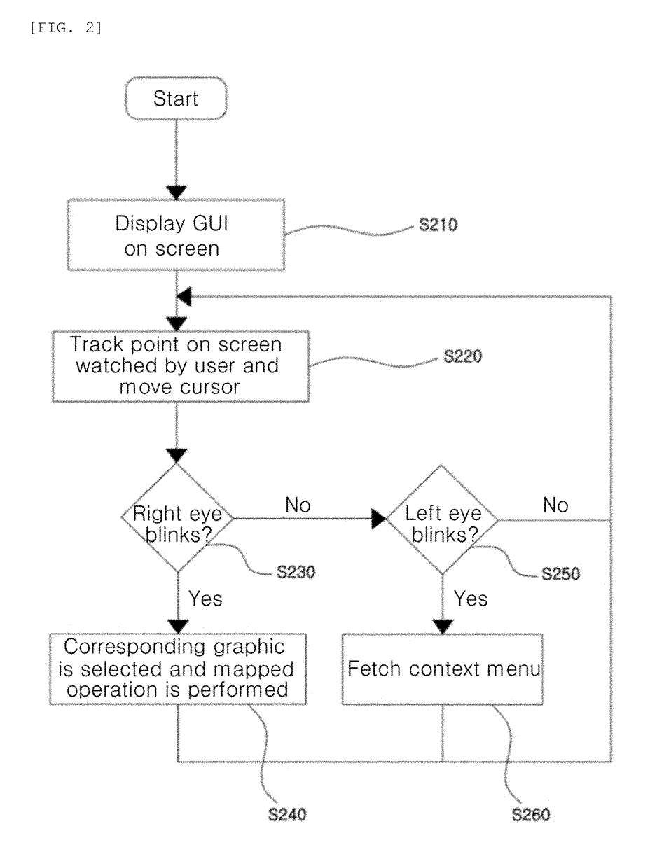

FIG. 2 is a flowchart illustrating a process of processing, by a user, a graphic entity displayed on the head mount display with both eyes according to an embodiment of the present invention.

The process is described with reference to FIG. 2. When a GUI is displayed on a screen (S210), a point on the screen at which a user looks may be tracked through the camera module 120, and a specific cursor may be controlled so that it moves on the GUI with reference to the tracked point (S220).

In this case, at least one graphic entity may be included in the GUI and displayed. The user may perform a command through a motion of at least any one of both eyes in the state in which the point to which the cursor has moved corresponds to the location of a specific graphic entity of the at least one graphic entity.

Specifically, since a motion of the eye is various, a combination of a plurality of motions can be formed using the various motions of the eye and the graphic entity can be controlled in various ways with reference to the combination of the plurality of motions.

For example, when the user blinks his or her right eye (S230), the specific graphic entity located at the point to which the cursor has moved may be clicked on, so a corresponding command may be executed (S240). When the user blinks his or her left eye (S250), the specific graphic entity is clicked on, so a detailed selection item corresponding to the specific graphic entity may be fetched and displayed (S260).

In this case, the corresponding command may be selection for the graphic entity, and the detailed selection item corresponding to the graphic entity may be a context menu.

If the user does not blink his or her eye for a specific time in the state at step S220, the eyes of the user may be recognized again and step S220 may continue.

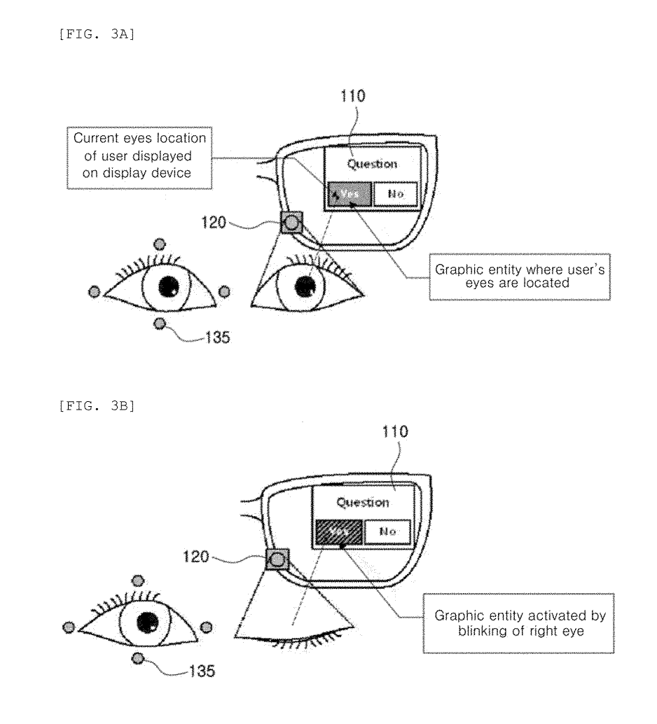

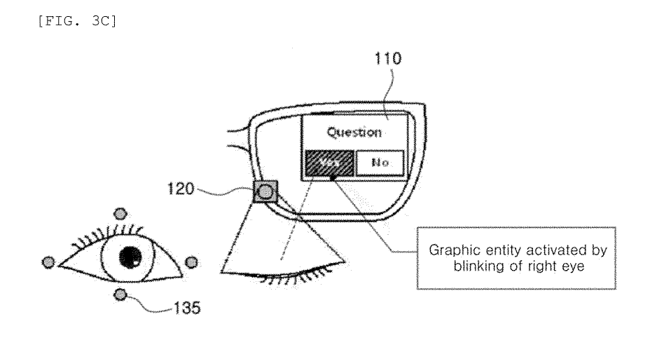

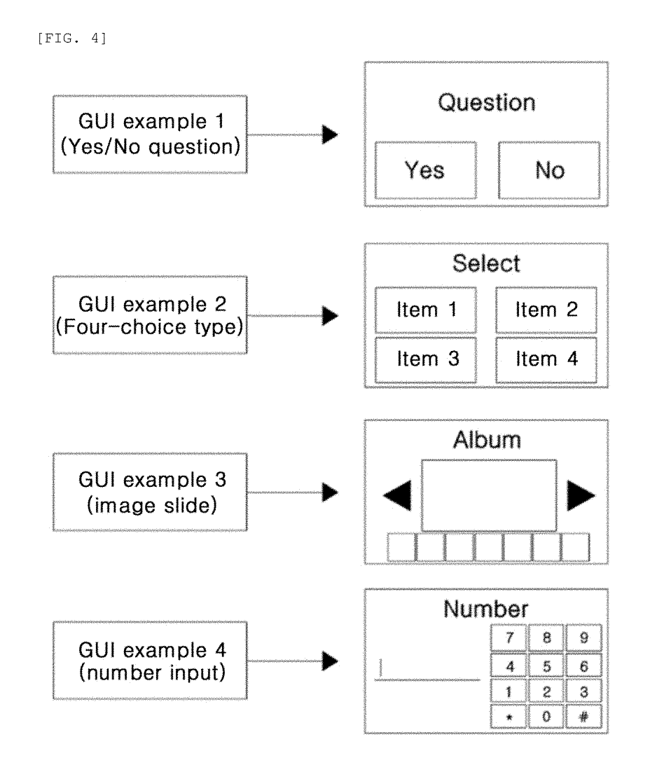

FIGS. 3a to 3c illustratively show a process of selecting, by a user, a graphic entity displayed on the head mount display with both eyes according to an embodiment of the present invention. For reference, it is to be noted that in FIGS. 3a to 3c, unlike in FIG. 1, the camera module 120 is disposed in a portion corresponding to the left eye and the EOG electrode 135 is disposed in a portion corresponding to the right eye. That is, it does not matter whether the camera module 120 is disposed on any one eye side as in FIG. 1 or 3, and the EOG electrode 135 may be disposed on the eye side in which the camera module 120 is not disposed.

Referring to FIG. 3a, when a user looks at any one portion of a GUI displayed on the display unit 110 disposed on the upper side of the left lens of the head mount display device 100, the camera module 120 disposed on one side of the left lens of the head mount display device 100 can recognize the eyes of the user. In this case, from FIG. 3b, it may be seen that when the eyes of the user are located in a specific graphic entity included in the GUI and the user blinks his or her left eye, the specific graphic entity is selected. From FIG. 3c, it may be seen that when the user blinks his or her right eye, a context menu corresponding to the specific graphic entity is fetched and displayed.

FIG. 4 illustratively shows a GUI displayed on the head mount display according to an embodiment of the present invention.

FIG. 4 illustratively shows a GUI displayed on the head mount display according to an embodiment of the present invention. The GUI is displayed at a specific location of a screen provided by the head mount display. Examples of the GUI may include a Yes/No question, a four-choice type, an image slide, number input and so on. A graphic entity output to the GUI is an entity which performs a command corresponding to motion information obtained from the right eye of a user through the camera module and motion information obtained from the left eye of the user through the bio-signal acquisition module, and may include a Yes/No selection entity, an item entity, an image slide entity, a number input button entity, for example, but is not limited thereto.

The aforementioned embodiments according to the present invention may be implemented in the form of program instructions that can be executed by a variety of computer elements, and may be stored in a computer-readable storage medium. The computer-readable storage medium may include program instructions, a data file, and a data structure solely or in combination. The program instructions that are stored in the medium may be designed and constructed particularly for the present invention, or may be known and available to those skilled in the field of computer software. Examples of the computer-readable storage medium include magnetic media such as a hard disk, a floppy disk and a magnetic tape, optical media such as CD-ROM and a DVD, magneto-optical media such as a floptical disk, and hardware devices particularly configured to store and execute program instructions such as ROM, RAM, and flash memory. Examples of the program instructions include not only machine language code that is constructed by a compiler but also high-level language code that can be executed by a computer using an interpreter or the like. The aforementioned hardware components may be configured to act as one or more software modules that perform processing according to the present invention, and vice versa.

Although the present invention has been described in connection with specific matters, such as the detailed elements, and the limited embodiments and drawings, they have been provided only to help more general understanding of the present invention, and the present invention is not limited to the embodiments. A person having ordinary skill in the art to which the present invention pertains may modify the embodiments in various ways from the above description.

Accordingly, the spirit of the present invention should not be limited and defined by the described embodiments, and it may be said that the claims to be described later and all of things equally or equivalently modified from respect to the claims belong to the category of the spirit of the present invention.

### INDUSTRIAL APPLICABILITY

Accordingly, in accordance with the present invention, a measurement module applied to a first eyeball and a second eyeball is divided into the camera module and the bio-signal acquisition module, and a variety of user inputs is implemented through the camera module and the bio-signal acquisition module. Accordingly, a mass production and selling possibility can be secured due to an effect in that the present invention can be used in a user-friendly manner compared to a common HMD, and the present invention corresponds to an invention having sufficient industrial applicability through mass production according to standardization.

1. A method of providing a user interface through a head mount display using eyes recognition and a bio-signal, comprising steps of:
(a) moving a cursor to a specific location watched by a user with reference to eyes information obtained from a first eyeball that is any one of eyeballs of the user through a camera module when the user looks at the specific location of a displayed screen, and
(b) providing support so that a detailed selection item corresponding to a specific entity is provided with reference to motion information obtained from an eyelid corresponding to a second eyeball that is any one of the eyeballs of the user through a bio-signal acquisition module in a state in which the specific entity is present at the specific location.

2. The method of claim 1, wherein at the step (b), the support is provided so that the entity is selected with reference to motion information obtained from an eyelid corresponding to the first eyeball of the user through the camera module.

3. The method of claim 1, wherein the first eyeball and the second eyeball are one identical eyeball of the user.

4. The method of claim 1, wherein:
the bio-signal acquisition module comprises a plurality of electrodes attached to a skin around the second eyeball, and
locations for recognizing a direction of a motion of the eyelid corresponding to the second eyeball are determined to be locations where the plurality of electrodes is attached.

5. The method of claim 1, wherein the eyes information obtained from the first eyeball of the user is derived by a processor which performs a specific eyes tracking algorithm and the camera module which photographs the first eyeball of the user.

6. The method of claim 5, wherein the eyes tracking algorithm photographs the first eyeball of the user using the camera module, searches the photographed image for a central location of a pupil of the first eyeball, and calculates a point on the screen watched by the user.

7. The method of claim 1, wherein the bio-signal comprises information according to electrooculogram (EOG).

8. A head mount display device providing a user interface using eyes recognition and a bio-signal, the device comprising:
a camera module which obtains eyes information from a first eyeball that is any one of eyeballs of a user,
a bio-signal acquisition module which obtains motion information from an eyelid corresponding to a second eyeball that is any one of the eyeballs of the user, and
a user interface providing unit (1) which moves a cursor to a specific location watched by the user with reference to the eyes information obtained from the first eyeball of the user through the camera module when the user looks at the specific location of a displayed screen and (2) which provides support so that a detailed selection item corresponding to a specific entity is provided with reference to the motion information obtained from the eyelid corresponding to the second eyeball of the user through the bio-signal acquisition module in a state in which the specific entity is present at the specific location.

9. The head mount display device of claim 8, wherein the user interface providing unit provides support so that the graphic entity is selected with reference to motion information obtained from an eyelid corresponding to the first eyeball of the user through the camera module.

10. The head mount display device of claim 8, wherein the first eyeball and the second eyeball are one identical eyeball of the user.

11. The head mount display device of claim 8, wherein:
the bio-signal acquisition module comprises a plurality of electrodes attached to a skin around the second eyeball, and
locations for recognizing a direction of a motion of the eyelid corresponding to the second eyeball are determined to be locations where the plurality of electrodes is attached.

12. The head mount display device of claim 8, wherein the camera module photographs the first eyeball of the user and obtains the eyes information obtained from the first eyeball of the user under a support of the processor performing a specific eyes tracking algorithm.

13. The head mount display device of claim 12, wherein the camera module obtains the eyes information obtained from the first eyeball of the user under a support of an eyes tracking algorithm which photographs the first eyeball of the user, searches the photographed image for a central location of a pupil of the first eyeball, and calculates a point on the graphic user interface watched by the user.

14. The head mount display device of claim 8, wherein the bio-signal comprises information according to electrooculogram (EOG).

15. The head mount display device of claim 8, wherein the screen is disposed outside glasses.

16. A computer-readable recording medium on which a computer program for executing a method according to claim 1 has been recorded.
